(19) United States
(12) Patent Application Publication
(10) Pub. No.: US 2019/0252717 A1
(43) Pub. Date: Aug. 15, 2019

(54) LITHIUM-ION RECHARGEABLE BATTERY, AND METHOD FOR PRODUCING LITHIUM-ION RECHARGEABLE BATTERY

(71) Applicants: SHOWA DENKO K.K., Tokyo (JP); SHOWA DENKO PACKAGING CO., LTD., Isehara-shi, Kanagawa (JP)

(72) Inventors: Akira SAKAWAKI, Ichihara-shi, Chiba (JP); Takaki YASUDA, Ichihara-shi, Chiba (JP); Koji MINAMITANI, Isehara-shi, Kanagawa (JP)

(73) Assignees: SHOWA DENKO K.K., Tokyo (JP); SHOWA DENKO PACKAGING CO., LTD., Isehara-shi, Kanagawa (JP)

(21) Appl. No.: 16/345,338

(22) PCT Filed: Oct. 11, 2017
(86) PCT No.: PCT/JP2017/036836

§ 371 Date: Apr. 26, 2019

(30) Foreign Application Priority Data
Nov. 25, 2016 (JP) 2016-229554
May 11, 2017 (JP) 2017-094347

(51) Int. Cl. H01M 10/0525; H01M 10/0585; H01M 10/0562; H01M 2/02

(52) U.S. Cl. CPC H01M 10/0525; H01M 2/0285; H01M 10/0562; H01M 10/0585

(57) ABSTRACT

A lithium-ion rechargeable battery (1) including: a battery unit (50) including a metal substrate (5) and a battery part (10) formed on a surface of the substrate (5); and a shell (30) for housing the battery part (10) in the interior thereof. The shell (30) includes a laminated film (31) that includes a metal layer (313) and a thermo-adhesive resin layer (315), the metal layer (313) is connected to a negative electrode collector layer (14) of the battery part (10), the substrate (5) functions as a positive external electrode of the battery part (10), and the metal layer (313) functions as a negative external electrode of the battery part (10).

### TECHNICAL FIELD

The present invention relates to a lithium-ion rechargeable battery and a method for producing the lithium-ion rechargeable battery.

### BACKGROUND ART

A lithium-ion rechargeable battery is known, which is provided with: a battery part including a positive electrode containing a positive-electrode active material, a negative electrode containing a negative-electrode active material, and an electrolyte having lithium-ion conductivity and interposed between the positive electrode and the negative electrode; and a shell that houses the battery part to seal the battery part against outside air or the like.

The shell of the lithium-ion rechargeable battery is required to have high barrier properties against gases, liquids and solids. In Patent Document 1, it is described that a shell is configured by using a laminated shell material formed by laminating a metallic foil layer and a thermo-adhesive resin layer and by thermally adhering thermo-adhesive films to each other.

Moreover, as the electrolyte constituting the battery part, an organic electrolytic solution or the like has been conventionally used. In contrast thereto, in Patent Document 2, it is described that a solid electrolyte made of an inorganic material is used as the electrolyte, and all of the negative electrode, the solid electrolyte and the positive electrode are configured with thin films.

### CITATION LIST

### Patent Literature

Patent Document 1: Japanese Patent Application Laid-Open Publication No. 2016-129091

Patent Document 2: Japanese Patent Application Laid-Open Publication No. 2013-73846

### SUMMARY OF INVENTION

### Technical Problem

Here, when the lithium-ion rechargeable battery was configured by using the battery part of the thin-film type and the shell to house the battery part inside thereof, it was necessary to provide positive and negative electrodes (tab electrodes) for the battery part separately from the substrate on which the shell and the battery part were to be formed.

An object of the present invention is to simplify a configuration of a thin-film type lithium-ion rechargeable battery including a solid electrolyte.

### Solution to Problem

A lithium-ion rechargeable battery to which the present invention is applied includes: a substrate having conductivity; a battery part including a first polarity layer laminated on one surface of the substrate to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and a laminated film including a metal layer and a resin layer laminated on the metal layer to form an exposed portion, where a part of the metal layer is exposed, on one surface of the metal layer, the metal layer being electrically connected to the second polarity layer at the exposed portion, the laminated film sealing the battery part in a state where the metal layer is electrically insulated from the substrate.

In the lithium-ion rechargeable battery like this, the battery part further includes another first electrode layer laminated on the other surface of the substrate to occlude and release a lithium ion at the first polarity, another solid electrolyte layer laminated on the another first electrode layer and including an inorganic solid electrolyte having lithium-ion conductivity, and another second electrode layer laminated on the another solid electrolyte layer to occlude and release a lithium ion at the second polarity, and another exposed portion is further formed in the laminated film, and the metal layer is electrically connected to the another second polarity layer at the another exposed portion.

Moreover, the battery part is disposed at an interior of the laminated film folded to have the resin layer at the interior thereof, and the battery part is sealed by adhesion of the resin layer.

Further, a part of the substrate is exposed without being covered with the laminated film.

Still further, the second polarity layer provided to the battery part and the metal layer exposed at the exposed portion of the laminated film are in direct contact with each other.

Moreover, from another standpoint, a method for producing a lithium-ion rechargeable battery includes: a process of depositing a first polarity layer on one surface of a substrate, the first polarity layer occluding and releasing a lithium ion with a first polarity; a process of depositing a solid electrolyte layer on the first polarity layer, the solid electrolyte layer containing an inorganic solid electrolyte having lithium-ion conductivity; a process of depositing a second polarity layer on the solid electrolyte layer, the second polarity layer occluding and releasing a lithium ion with a second polarity, which is opposite to the first polarity; and a process of sealing the first polarity layer, the solid electrolyte layer and the second polarity layer by adhesion of a resin layer, of a laminated film including a metal layer and the resin layer laminated on one surface of the metal layer to form an exposed portion where a part of the metal layer is exposed, in a state where the laminated film is disposed to cause the metal layer exposed at the exposed portion to face the second polarity layer.

### Advantageous Effects of Invention

According to the present invention, it is possible to simplify a configuration of a thin-film type lithium-ion rechargeable battery including a solid electrolyte.

### BRIEF DESCRIPTION OF DRAWINGS

FIGS. 1A and 1B are diagrams for illustrating an overall configuration of a lithium-ion rechargeable battery to which Exemplary embodiment 1 is applied;

FIG. 2 is a II-II cross-sectional view of FIG. 1A;

FIGS. 3A and 3B are perspective views of a battery unit in Exemplary embodiment 1;

FIGS. 4A and 4B are perspective views of a laminated film in Exemplary embodiment 1;

FIG. 5 is a flowchart for illustrating a method of producing the lithium-ion rechargeable battery;

FIGS. 6A and 6B are diagrams for illustrating an overall configuration of a lithium-ion rechargeable battery to which Exemplary embodiment 2 is applied;

FIG. 7 is a VII-VII cross-sectional view of FIG. 6A;

FIGS. 8A and 8B are perspective views of a battery unit in Exemplary embodiment 2;

FIGS. 9A and 9B are perspective views of a laminated film in Exemplary embodiment 2;

FIG. 10 is a diagram for illustrating a modified example of Exemplary embodiment 1, which is a II-II cross-sectional view of FIG. 1A;

FIGS. 11A and 11B are perspective views of a battery unit in the modified example of Exemplary embodiment 1;

FIG. 12 is a diagram for illustrating a modified example of Exemplary embodiment 2, which is a VII-VII cross-sectional view of FIG. 6A; and

FIGS. 13A and 13B are perspective views of a battery unit in the modified example of Exemplary embodiment 2.

### DESCRIPTION OF EMBODIMENTS

Hereinafter, exemplary embodiments according to the present invention will be described in detail with reference to attached drawings. Note that, the size, thickness or the like of each component in the drawings referenced in the following description will differ from the actual dimension in some cases.

### Exemplary Embodiment 1

### [Configuration of Lithium-Ion Rechargeable Battery]

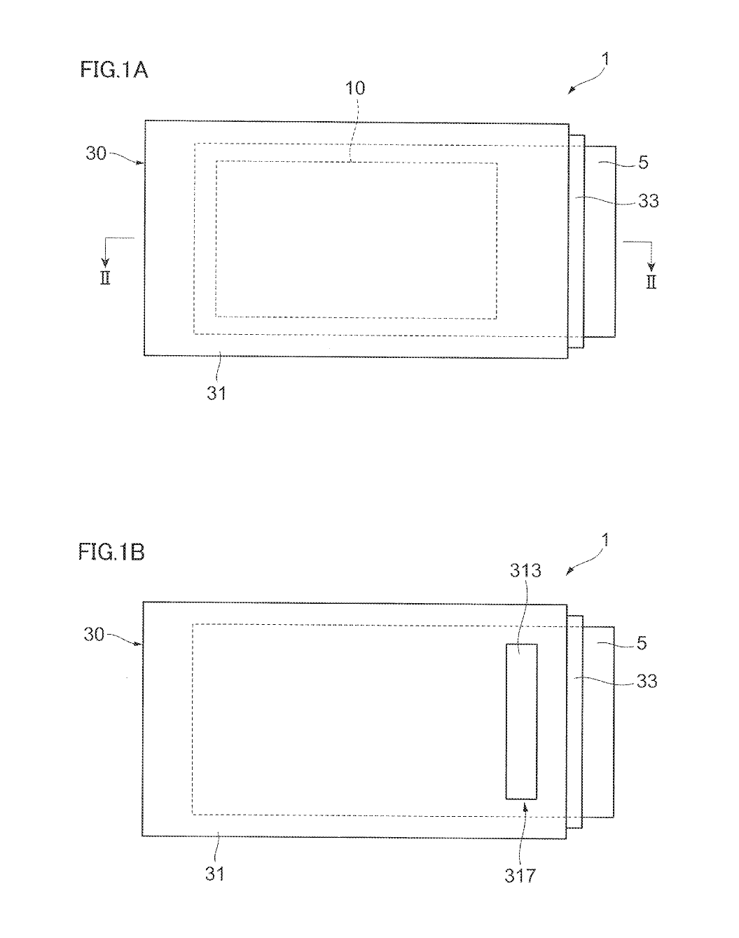

FIG. 1 is a diagram for illustrating an overall configuration of a lithium-ion rechargeable battery 1 to which Exemplary embodiment 1 is applied. Here, FIG. 1A is a diagram in which the lithium-ion rechargeable battery 1 is viewed from the front (front surface), and FIG. 1B is a diagram in which the lithium-ion rechargeable battery 1 is viewed from the back (back surface).

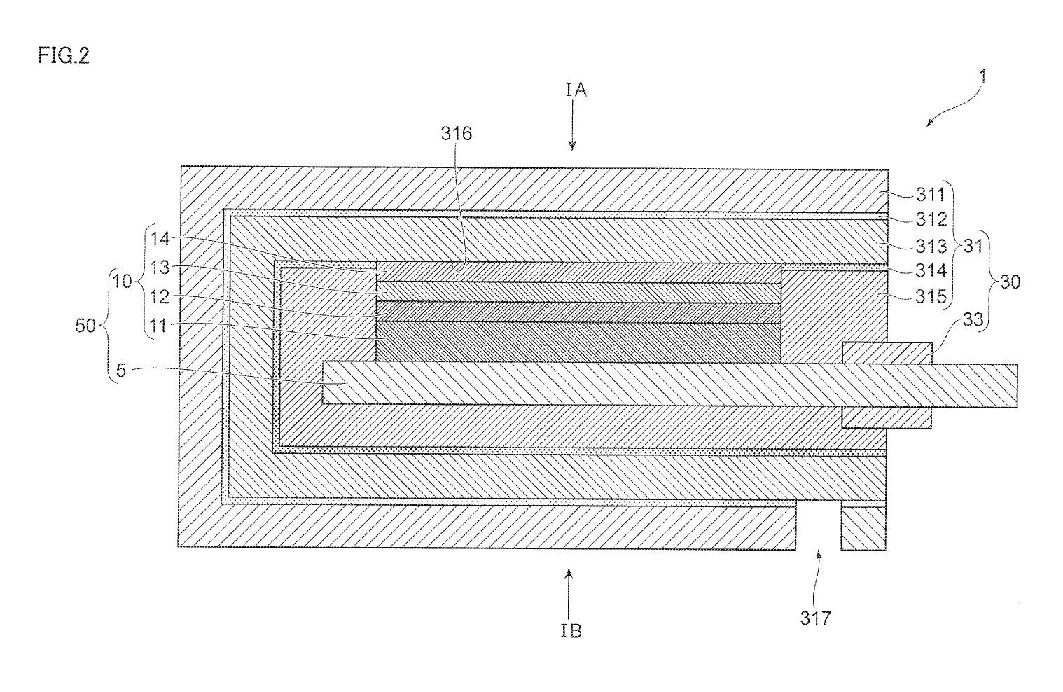

Moreover, FIG. 2 shows a II-II cross-sectional view of FIG. 1A. Note that FIG. 1A is a diagram viewing FIG. 2 from the IA direction, and FIG. 1B is a diagram viewing FIG. 2 from the IB direction.

The lithium-ion rechargeable battery 1 of the exemplary embodiment includes: a battery unit 50 including a battery part 10 that performs charge and discharge using lithium ion; and a shell 30 that seals the battery part 10 against outside air or the like by housing the battery part 10 in the interior thereof. The lithium-ion rechargeable battery 1 of the exemplary embodiment shows a rectangular-parallelepiped shape (in actuality, a card shape) as a whole.

### [Configuration of Battery Unit]

The battery unit 50 includes: a substrate 5 that functions as one electrode (here, a positive electrode) in the lithium-ion rechargeable battery 1; and a battery part 10 provided to the one surface (referred to as a front surface) of the substrate 5. In the exemplary embodiment, as will be described later, since the battery part 10 is formed on the front surface of the substrate 5 by the sputtering method, the battery unit 50 has a configuration integrating the substrate 5 and the battery part 10.

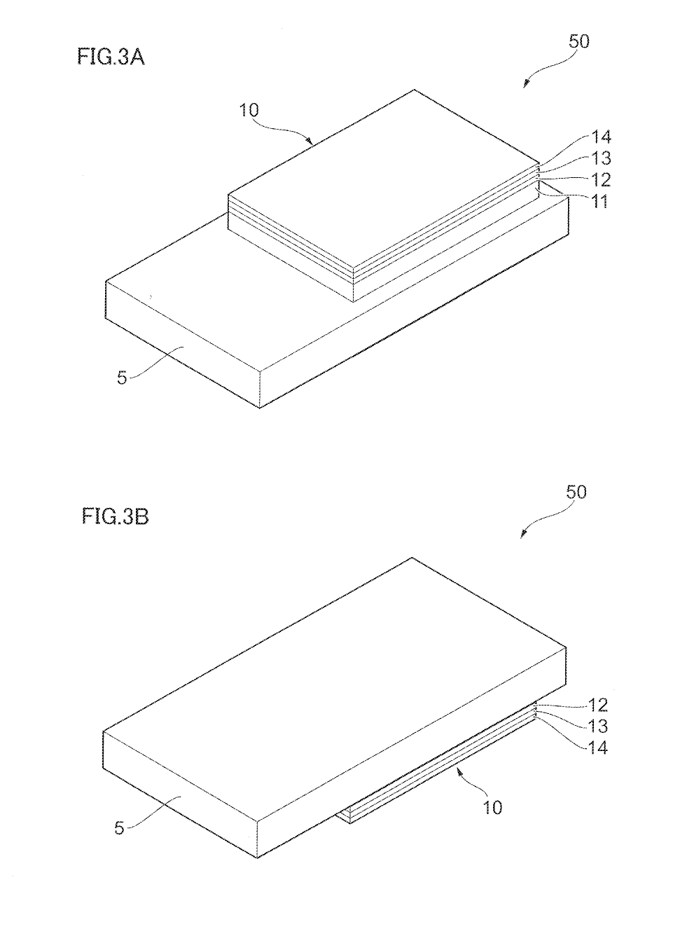

FIG. 3 shows diagrams for illustrating the configuration of the battery unit 50 in the exemplary embodiment: FIG. 3A shows a perspective view that is viewed from the front side (in FIG. 2, from above); and FIG. 3B shows a perspective view that is viewed from the back side (in FIG. 2, from below). Hereinafter, the configuration of the battery unit 50 will be described with reference to FIG. 3 in addition to FIGS. 1 and 2.

### [Substrate]

The substrate 5 is not particularly limited as long as being a thin-plate shaped member having conductivity and being suitable to deposition by the sputtering method, and, for example, various kinds of metal plates can be used. However, considering that the substrate 5 is used for forming the battery part 10 by the sputtering method, it is preferable to use stainless foil having high mechanical strength. Moreover, metallic foil, which is obtained by plating with conductive metals, such as nickel, tin, copper, chrome and the like, may be used. In the exemplary embodiment, as the substrate 5, the stainless foil was used.

The thickness of the substrate 5 can be set in the range of 20 μm or more and 200 μm or less. When the thickness of the substrate 5 is less than 20 μm, a pinhole or breaking is likely to occur in rolling or heat sealing in manufacturing the metallic foil, and in addition, the electrical resistance value when being used as the positive electrode is increased. On the other hand, when the thickness of the substrate 5 exceeds 200 μm, a volume energy density and a weight energy density are reduced by increases in the thickness and the weight of the battery. Moreover, flexibility of the battery is reduced. In the exemplary embodiment, the thickness of the substrate 5 was set to 30 μm.

### [Battery Part]

The battery part 10 includes: a positive electrode layer 11 laminated on the front surface (the upper side in FIG. 2) of the substrate 5; a solid electrolyte layer 12 laminated on the positive electrode layer 11; a negative electrode layer 13 laminated on the solid electrolyte layer 12; and a negative electrode collector layer 14 laminated on the negative electrode layer 13. Here, the positive electrode layer 11 positioned on one end portion of the battery part 10 (the lower side in FIG. 2) is in contact with the front surface of the substrate 5. In contrast thereto, the negative electrode collector layer 14 positioned on the other end portion of the battery part 10 (the upper side in FIG. 2) is in contact with a metal layer 313 provided to a laminated film 31, which will be described later.

Each constituent of the battery part 10 will be described in more detail.

### (Positive Electrode Layer)

The positive electrode layer 11 as an example of a first polarity layer is not particularly limited as long as the layer is a solid thin film that contains a positive-electrode active material occluding and releasing a lithium ion with a positive polarity as an example of a first polarity, and, for example, those configured with various kinds of materials, such as oxides, sulfides or phosphorus oxides containing at least one kind of metal selected from manganese (Mn), cobalt (Co), nickel (Ni), iron (Fe), molybdenum (Mo) and vanadium (V), may be used. In the exemplary embodiment, as the positive electrode layer 11, Li₂Mn₂O₄ was used.

The thickness of the positive electrode layer 11 can be set in the range of, for example, 10 nm or more and 40 μm or less. When the thickness of the positive electrode layer 11 is less than 10 nm, the capacity of the battery part 10 to be obtained becomes too small, and impractical. On the other hand, when the thickness of the positive electrode layer 11 exceeds 40 μm, it takes too much time to form the layer, and thereby, the productivity is deteriorated. In the exemplary embodiment, the thickness of the positive electrode layer 11 was set to 600 nm.

Moreover, it does not matter whether the positive electrode layer 11 includes crystal structures or is in the amorphous state without including the crystal structures; however, in the point that expansion and contraction associated with occluding and releasing of lithium ions are more isotropic, it is preferable that the positive electrode layer 11 is in the amorphous state.

Further, as the manufacturing method of the positive electrode layer 11, known deposition methods, such as various kinds of PVD (physical vapor deposition) or various kinds of CVD (chemical vapor deposition), may be used; however, in terms of production efficiency, it is desirable to use the sputtering method (sputtering). In this case, in accordance with a sputtering target to be used in forming the positive electrode layer 11, the DC sputtering method or the RF sputtering method may be used. However, in the case where the above-described Li₂Mn₂O₄ is used for the positive electrode layer 11, it is preferable to adopt the RF sputtering method.

### (Solid Electrolyte Layer)

The solid electrolyte layer 12 is not particularly limited as long as being a solid thin film composed of an inorganic material (inorganic solid electrolyte) having lithium-ion conductivity, and those configured with various kinds of materials, such as oxides, nitrides or sulfides, may be used. In the exemplary embodiment, as the solid electrolyte layer 12, LiPON (LiₓPO_{y}N_{z}), which was obtained by replacing a part of oxygen in Li₃PO₄ with nitrogen, was used.

The thickness of the solid electrolyte layer 12 can be set in the range of, for example, 10 nm or more and 10 μm or less. When the thickness of the solid electrolyte layer 12 is less than 10 nm, in the obtained battery part 10, leakage is likely to occur between the positive electrode layer 11 and the negative electrode layer 13. On the other hand, when the thickness of the solid electrolyte layer 12 exceeds 10 μm, the moving distance of lithium ion is elongated, and thereby, the charge and discharge rate is reduced. In the exemplary embodiment, the thickness of the solid electrolyte layer 12 was set to 200 nm.

Moreover, it does not matter whether the solid electrolyte layer 12 includes crystal structures or is in the amorphous state without including the crystal structures; however, in the point that expansion and contraction due to heat are more isotropic, it is preferable that the solid electrolyte layer 12 is in the amorphous state.

Further, as the manufacturing method of the solid electrolyte layer 12, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets used in forming the solid electrolyte layer 12 are insulating bodies, it is preferable to adopt the RF sputtering method.

### (Negative Electrode Layer)

The negative electrode layer 13 as an example of a second polarity layer is not particularly limited as long as the layer is a solid thin film that contains a negative-electrode active material occluding and releasing lithium ions with a negative polarity as an example of a second polarity, and, for example, carbon (C) or silicon (Si) can be used. In the exemplary embodiment, as the negative electrode layer 13, silicon (Si) added with boron (B) was used.

The thickness of the negative electrode layer 13 can be set in the range of, for example, 10 nm or more and 40 μm or less. When the thickness of the negative electrode layer 13 is less than 10 nm, the capacity of the battery part 10 to be obtained becomes too small, and impractical. On the other hand, when the thickness of the negative electrode layer 13 exceeds 40 μm, it takes too much time to form the layer, and thereby, the productivity is deteriorated. In the exemplary embodiment, the thickness of the negative electrode layer 13 was set to 100 nm.

Moreover, it does not matter whether the negative electrode layer 13 includes crystal structures or is in the amorphous state without including the crystal structures; however, in the point that expansion and contraction associated with occluding and releasing of lithium ions are more isotropic, it is preferable that the negative electrode layer 13 is in the amorphous state.

Further, as the manufacturing method of the negative electrode layer 13, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets for forming the negative electrode layer 13 are semiconductors, it is preferable to adopt the DC sputtering method.

### (Negative Electrode Collector Layer)

The negative electrode collector layer 14 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals. In the exemplary embodiment, as the negative electrode collector layer 14, titanium (Ti) was used.

The thickness of the negative electrode collector layer 14 can be set in the range of, for example, 5 nm or more and 50 μm or less. When the thickness of the negative electrode collector layer 14 is less than 5 nm, the power collection function is deteriorated, to thereby become impractical. On the other hand, when the thickness of the negative electrode collector layer 14 exceeds 50 μm, it takes too much time to form the layer, and thereby, the productivity is deteriorated. In the exemplary embodiment, the thickness of the negative electrode collector layer 14 was set to 200 nm.

Moreover, as the manufacturing method of the negative electrode collector layer 14, known deposition methods, such as various kinds of PVD (physical vapor deposition) or various kinds of CVD (chemical vapor deposition), may be used; however, in terms of production efficiency, it is desirable to use the sputtering method (sputtering). In this case, since the sputtering target for forming the negative electrode collector layer 14 is a metal (Ti), it is preferable to adopt the DC sputtering method.

### [Configuration of Shell]

Subsequently, a configuration of the shell 30 will be described.

The shell 30 includes: a laminated film 31 made by laminating plural layers; and a thermo-adhesive film 33 for thermally adhering the laminated film 31 and the battery unit 50 (more specifically, the substrate 5). Then, in the shell 30, in a state in which the laminated film 31 is folded in two and the battery unit 50 is disposed inside thereof, the laminated film 31 and the thermo-adhesive film 33 are thermally adhered to the entire circumference around the battery part 10, and thereby the battery part 10 is sealed. However, in the shell 30, the battery part 10 is sealed in a state in which one end of the substrate 5 in the battery unit 50 is exposed to the outside.

### [Laminated Film]

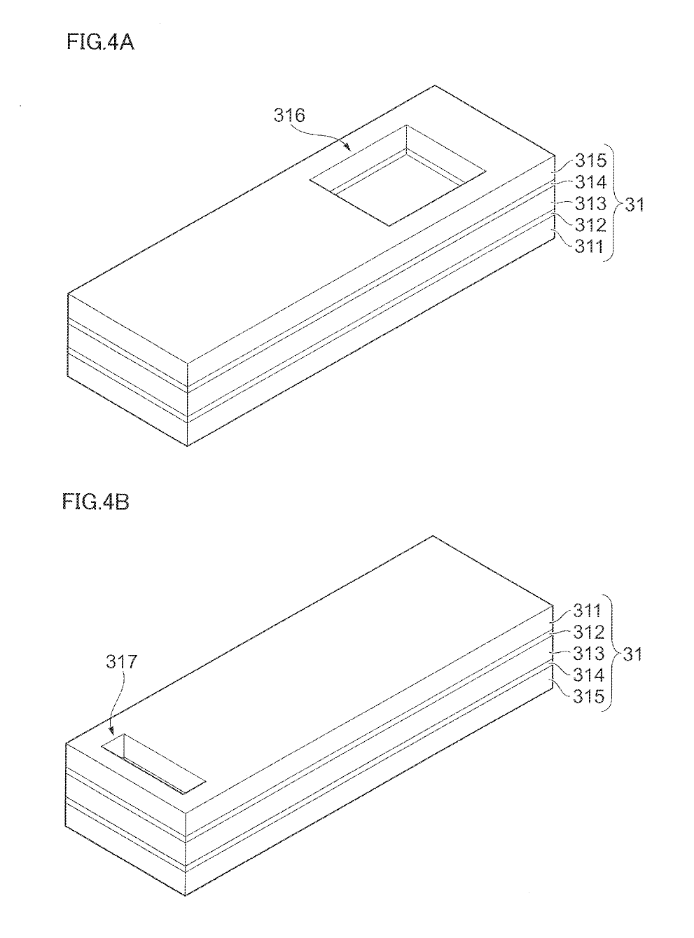

FIG. 4 shows diagrams for illustrating the configuration of the laminated film 31 in the exemplary embodiment: FIG. 4A shows a perspective view of an area that comes to the inside when the laminated film 31 is folded in two; and FIG. 4B shows a perspective view of an area that comes to the outside when the laminated film 31 is folded in two. Hereinafter, the configuration of the laminated film 31 will be described with reference to FIG. 4 in addition to FIGS. 1 to 3.

The laminated film 31 is configured by laminating a heat-resistant resin layer 311, an outside adhesion layer 312, a metal layer 313, an inside adhesion layer 314 and a thermo-adhesive resin layer 315 in a film-like shape in this order. In other words, the laminated film 31 is configured by bonding the heat-resistant resin layer 311, the metal layer 313 and the thermo-adhesive resin layer 315 via the outside adhesion layer 312 and the inside adhesion layer 314.

Moreover, on a formation surface side of the laminated film 31, on which the thermo-adhesive resin layer 315 is formed (inside in the shell 30), there is provided an inside exposed part 316 as an example of an exposed portion where a part of one surface of the metal layer 313 (inside surface) is exposed due to absence of the thermo-adhesive resin layer 315 and the inside adhesion layer 314. Here, the inside exposed part 316 serves as an area for housing the battery part 10 of the battery unit 50.

Further, on a formation surface side of the laminated film 31, on which the heat-resistant resin layer 311 is formed (outside in the shell 30), there is provided an outside exposed part 317 where a part of the other surface of the metal layer 313 (outside surface) is exposed due to absence of the outside adhesion layer 312 and the heat-resistant resin layer 311.

Next, each constituent of the laminated film 31 will be described in more detail.

### (Heat-Resistant Resin Layer)

The heat-resistant resin layer 311 is the outermost layer in the shell 30, and a heat-resistant resin, which has high resistance to sticking from the outside, abrasion or the like, and is not melted at the adhesive temperature in thermally adhering the thermo-adhesive resin layer 315, is used. Here, as the heat-resistant resin layer 311, it is preferable to use a heat-resistant resin having a melting point not less than 10° C. higher than a melting point of a thermo-adhesive resin constituting the thermo-adhesive resin layer 315, and particularly preferable to use a heat-resistant resin having a melting point not less than 20° C. higher than the melting point of the thermo-adhesive resin. Moreover, in the exemplary embodiment, as will be described later, the metal layer 313 also serves as the negative electrode of the battery part 10; therefore, in terms of safety, an insulating resin having high electrical resistance value is used as the heat-resistant resin layer 311.

As the heat-resistant resin layer 311, though not being particularly limited, examples thereof include polyamide films or polyester films, and oriented films thereof are preferably used. Among them, in terms of moldability and strength, it is particularly preferable to use a biaxially oriented polyamide film, a biaxially oriented polyester film or a multi-layered film containing these biaxially stretched films, and further, it is preferable to use a multi-layered film made by bonding the biaxially oriented polyamide film and the biaxially oriented polyester film. As the polyamide film, though not being particularly limited, examples thereof include a 6-polyamide film, a 6,6-polyamide film and an MXD polyamide film. Moreover, as the biaxially oriented polyester film, examples include a biaxially oriented polybutylene terephthalate (PBT) film and a biaxially oriented polyethylene terephthalate (PET) film. In the exemplary embodiment, as the heat-resistant resin layer 311, a nylon film (the melting point: 220° C.) was used.

The thickness of the heat-resistant resin layer 311 can be set in the range of 9 μm or more to 50 μm or less. When the thickness of the heat-resistant resin layer 311 is less than 9 μm, it becomes difficult to secure the sufficient strength as the shell 30 of the battery part 10. On the other hand, when the thickness of the heat-resistant resin layer 311 exceeds 50 μm, since the battery becomes thick, it is not preferable. Moreover, the production costs are increased. In the exemplary embodiment, the thickness of the heat-resistant resin layer 311 was set to 25 μm.

### (Outside Adhesion Layer)

The outside adhesion layer 312 adheres the heat-resistant resin layer 311 and the metal layer 313. As the outside adhesion layer 312, for example, it is preferable to use two-pack curable type polyester-urethane resin by polyester resin as a base resin and polyfunctional isocyanate compound as a curing agent, or an adhesive agent containing polyether-urethane resin. In the exemplary embodiment, as the outside adhesion layer 312, the two-pack curable type polyester-urethane adhesive agent was used.

### (Metal Layer)

The metal layer 313 has a role, when the shell 30 is configured by using the laminated film 31, in preventing oxygen, moisture or the like from entering the battery part 10, which is disposed inside of the shell 30, from the outside thereof (barriering the battery part 10). Moreover, as will be described later, the metal layer 313 further has a role as a negative internal electrode, and a role as a negative external electrode of the battery part 10, the negative external electrode being electrically connected to a load provided outside (not shown). Therefore, as the metal layer 313, metallic foil having conductivity is used.

As the metal layer 313, though not being particularly limited, for example, aluminum foil, copper foil, nickel foil, stainless foil, clad foil thereof, annealed foil or unannealed foil thereof and the like are preferably used. Moreover, metallic foil, which is obtained by plating with conductive metals, such as nickel, tin, copper, chrome and the like, may be used. In the exemplary embodiment, as the metal layer 313, aluminum foil made of the A8021H-O material prescribed by JIS H4160 was used.

The thickness of the metal layer 313 can be set in the range of 20 μm or more and 200 μm or less. When the thickness of metal layer 313 is less than 20 μm, a pinhole or breaking is likely to occur in rolling or heat sealing in manufacturing the metallic foil, and in addition, the electrical resistance value when being used as the electrode is increased. On the other hand, when the thickness of the metal layer 313 exceeds 200 μm, in folding the laminated film 31 in two, a gap is likely to be generated at the folding portion. Moreover, there is a possibility that heat is dispersed in thermal adhesion and results in insufficient thermal adhesion. In the exemplary embodiment, the thickness of the metal layer 313 was set to 40 μm.

### (Inside Adhesion Layer)

The inside adhesion layer 314 adheres the metal layer 313 and the thermo-adhesive resin layer 315. As the inside adhesion layer 314, it is preferable to use an adhesive agent made of, for example, a polyurethane adhesive agent, an acrylic adhesive agent, an epoxy adhesive agent, a polyolefine adhesive agent, an elastomer adhesive agent, a fluorine adhesive agent or the like. Among them, it is preferable to use the acrylic adhesive agent or the polyolefine adhesive agent; in this case, the barrier properties of the laminated film 31 against water vapor can be improved. Moreover, it is preferable to use an adhesive agent of acid-denaturated polypropylene, polyethylene or the like. In the exemplary embodiment, as the inside adhesion layer 314, the acid-denaturated polypropylene adhesive agent was used.

### (Thermo-Adhesive Resin Layer)

The thermo-adhesive resin layer 315 as an example of a resin layer is an innermost layer in the shell 30, and, as the thermo-adhesive resin layer 315, a thermoplastic resin, which has high resistance to the materials constituting respective layers of the battery part 10 and is melted at the above-described adhesive temperature, to thereby adhere to the thermo-adhesive film 33, is used. Moreover, in the exemplary embodiment, as described above, the metal layer 313 also serves as the negative electrode of the battery part 10; therefore, in terms of safety, an insulating resin having high electrical resistance value is used as the thermo-adhesive resin layer 315.

As the thermo-adhesive resin layer 315, though not being particularly limited, for example, polyethylene, polypropylene, olefin copolymer, acid denaturation and ionomer thereof and so forth are preferably used. Here, examples of the olefin copolymer include: EVA (ethylene vinyl acetate copolymer); EAA (ethylene acrylic acid copolymer); and EMAA (ethylene methacrylic acid copolymer). Moreover, as long as relationship of melting point with the heat-resistant resin layer 311 can be satisfied, a polyamide film (for example, nylon 12) or a polyimide film can also be used. In the exemplary embodiment, as the thermo-adhesive resin layer 315, a cast polypropylene film (the melting point: 165° C.) was used.

The thickness of the thermo-adhesive resin layer 315 can be set in the range of 20 μm or more and 80 μm or less. When the thickness of the thermo-adhesive resin layer 315 is less than 20 μm, pinholes are likely to occur. On the other hand, when the thickness of the thermo-adhesive resin layer 315 exceeds 80 μm, since the battery becomes thick, it is not preferable. Moreover, since heat insulation properties are increased, there is a possibility of resulting in insufficient thermal adhesion. In the exemplary embodiment, the thickness of the thermo-adhesive resin layer 315 was set to 30 μm.

### [Thermo-Adhesive Film]

The thermo-adhesive film 33 is a layer (film) that thermally adheres the substrate 5 and the thermo-adhesive resin layer 315 in the laminated film 31. As the thermo-adhesive film, for example, it is preferable to use an acid-denaturated olefin film or the like, and, in particular, it is preferable to use a film made of maleic anhydride modified polypropylene (thickness of 50 μm to 150 μm) having high adhesiveness with metal.

### [Electrical Connection Structure in Lithium-Ion Rechargeable Battery]

Here, electrical connection structure in the lithium-ion rechargeable battery 1 of the exemplary embodiment will be described.

First, in the battery part 10, the positive electrode layer 11, the solid electrolyte layer 12, the negative electrode layer 13 and the negative electrode collector layer 14 are electrically connected in this order. Moreover, in the battery unit 50, the substrate 5 and the positive electrode layer 11 of the battery part 10 are electrically connected. Here, one end side of the substrate 5 is exposed to the outside without being covered with the shell 30; the portion can be electrically connected, as a positive electrode, to the load (not shown) provided outside.

The negative electrode collector layer 14 of the battery part 10 is electrically connected to a portion, of one surface (inside surface) of the metal layer 313 provided to the laminated film 31, exposed to the inside exposed part 316. Then, a part of the other surface (outside surface) of the metal layer 313 provided to the laminated film 31 is exposed at the outside exposed part 317 to the outside; the portion can be electrically connected, as a negative electrode, to the load (not shown) provided outside.

Consequently, in this example, the substrate 5 serves as the positive electrode of the lithium-ion rechargeable battery 1, and the metal layer 313 provided to the laminated film 31 serves as the negative electrode of the lithium-ion rechargeable battery 1. Here, the substrate 5 on the positive electrode side and the metal layer 313 on the negative electrode side are electrically insulated by the thermo-adhesive resin layer 315 provided to the laminated film 31 and the thermo-adhesive film 33.

### [Method for Producing Lithium-Ion Rechargeable Battery]

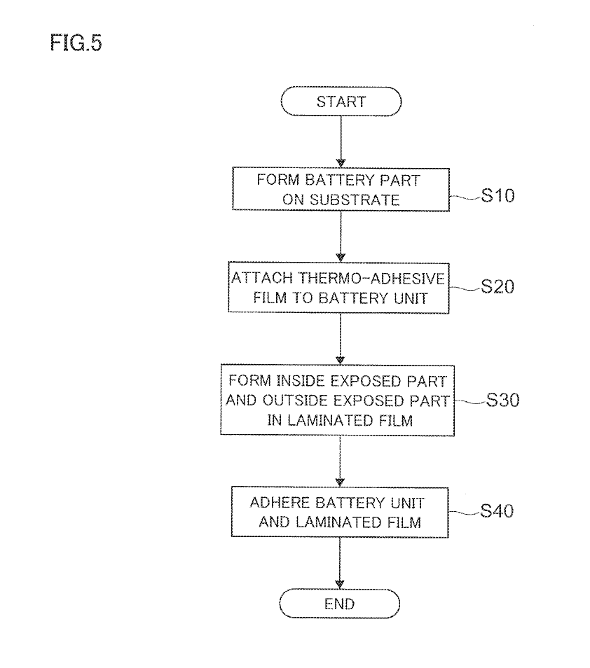

FIG. 5 is a flowchart for illustrating a method of producing the lithium-ion rechargeable battery 1 shown in FIG. 1 and so forth.

### (Battery Unit Formation Process)

First, the battery part 10 is formed on the front surface of the substrate 5 (step 10). In other words, on the front surface of the substrate 5, the positive electrode layer 11, the solid electrolyte layer 12, the negative electrode layer 13 and the negative electrode collector layer 14 are formed in this order, and thereby the battery unit 50 including the substrate 5 and the battery part 10 is obtained. Note that the details of step 10 will be described later.

### (Thermo-Adhesive Film Attachment Process)

Next, of the battery unit 50 obtained in step 10, the thermo-adhesive film 33 is attached all around the substrate 5 in the area serving as a border between the area in which the substrate 5 is to be covered with the shell 30 and the area in which the substrate 5 is not to be covered with the shell 30 (step 20).

### (Laminated Film Exposed Portion Formation Process)

Subsequently, from the laminated film 31 formed by bonding the heat-resistant resin layer 311, the metal layer 313 and the thermo-adhesive resin layer 315 via the outside adhesion layer 312 and the inside adhesion layer 314, a part of the heat-resistant resin layer 311, outside adhesion layer 312, the inside adhesion layer 314 and the thermo-adhesive resin layer 315 is removed. Consequently, in the laminated film 31, the inside exposed part 316 and the outside exposed part 317 are formed (step 30).

### (Adhesion Process)

Next, for example, into a working box filled with inert gas, such as N₂ gas or the like, the battery unit 50 to which the thermo-adhesive film 33 is attached and the laminated film 31 are introduced. Then, the negative electrode collector layer 14 provided to the battery part 10 of the battery unit 50 and the inside exposed part 316 provided to the laminated film 31 are caused to face each other. And then, the laminated film 31 is folded in two so that the battery unit 50 is positioned inside and a part of the substrate 5 is exposed to the outside.

Thereafter, in a state where the interior of the working box is set to the negative pressure, the thermo-adhesive resin layers 315 in the laminated film 31, as well as the thermo-adhesive resin layer 315 and the thermo-adhesive film 33 attached to the battery unit 50, are adhered to each other all around the outer periphery of the battery part 10 while being pressurized and heated (step 40). Then, due to the thermo-adhesive resin layer 315 and the thermo-adhesive film 33 thermally adhered, the lithium-ion rechargeable battery 1 including the substrate 5, the battery part 10, and the shell 30 that seals the battery part 10 is obtained.

At this time, the battery unit 50 is in a state in which the substrate 5 and the battery part 10 are joined (integrated) by deposition by the sputtering method. Moreover, the negative electrode collector layer 14 of the battery part 10 and the metal layer 313 of the laminated film 31 are brought into a state of being tightly adhered to each other by thermally adhering the thermo-adhesive resin layers 315 in the laminated film 31 to each other, as well as thermally adhering the thermo-adhesive resin layer 315 and the thermo-adhesive film 33 to each other, under the negative pressure.

### [Method for Producing Battery Unit]

Now, producing procedures of the battery unit 50 in the above step 10 will be described by taking specific examples.

### (Formation of Positive Electrode Layer)

First, the substrate 5 was placed in a deposition chamber (chamber) in a not-shown sputtering device. At this time, the front surface of the substrate 5 was made to face a sputtering target. After the substrate 5 was placed in the chamber, Ar gas containing 5% O₂ gas was introduced to set the pressure in the chamber at 0.8 Pa. And then, by use of a sputtering target having a composition of Li₂Mn₂O₄, formation (deposition) of the positive electrode layer 11 was performed on the front surface of the substrate 5 by the RF sputtering method. The film composition of the positive electrode layer 11 thus obtained was Li₂Mn₂O₄, the thickness thereof was 600 nm, and the crystal structure thereof was amorphous.

### (Formation of Solid Electrolyte Layer)

Next, N₂ gas was introduced to set the pressure in the chamber at 0.8 Pa. And then, by use of a sputtering target having a composition of Li₃PO₄, formation (deposition) of the solid electrolyte layer 12 was performed on the positive electrode layer 11 by the RF sputtering method. The film composition of the solid electrolyte layer 12 thus obtained was LiPON, the thickness thereof was 200 nm, and the crystal structure thereof was amorphous.

### (Formation of Negative Electrode Layer)

Subsequently, Ar gas was introduced to set the pressure in the chamber at 0.8 Pa. And then, by use of a sputtering target composed of silicon (Si) doped with boron (B) (a P-type Si sputtering target), formation (deposition) of the negative electrode layer 13 was performed on the solid electrolyte layer 12 by the DC sputtering method. The film composition of the negative electrode layer 13 thus obtained was Si doped with B, the thickness thereof was 100 nm, and the crystal structure thereof was amorphous.

### (Formation of Negative Electrode Collector Layer)

Further, in a state where Ar gas was introduced to set the pressure in the chamber at 0.8 Pa, by use of a sputtering target composed of titanium (Ti), formation (deposition) of the negative electrode collector layer 14 was performed on the negative electrode layer 13 by the DC sputtering method. The film composition of the negative electrode collector layer 14 thus obtained was Ti, and the thickness thereof was 200 nm.

By the above procedures, the battery unit 50 configured by forming the battery part 10 on the front surface of the substrate 5 was obtained. Then, the obtained battery unit 50 was taken out of the chamber.

### Conclusion of Exemplary Embodiment 1

As described above, according to the exemplary embodiment, the battery part 10 was formed on the front surface of the metal substrate 5 and the battery part 10 was housed inside of the shell 30. Moreover, in the exemplary embodiment, the battery part 10 and the metal layer 313 provided to the shell 30 were electrically connected. This makes it possible to simplify the configuration of the lithium-ion rechargeable battery 1 in which the battery part 10 is provided with the solid electrolyte layer 12.

### Exemplary Embodiment 2

In Exemplary embodiment 1, the lithium-ion rechargeable battery 1 was configured by housing a single (one) battery part 10 in the shell 30. In contrast thereto, in the exemplary embodiment, plural battery parts are housed inside of the shell 30 and the plural battery parts are connected in parallel by use of the substrate 5 and the shell 30, to thereby configure the lithium-ion rechargeable battery 1 having a larger capacity. Note that, in the exemplary embodiment, those similar to the exemplary embodiment 1 are assigned with same reference signs, and detailed descriptions thereof will be omitted.

Hereinafter, in the exemplary embodiment, the battery part 10 is referred to as a first battery part 10. Moreover, in the exemplary embodiment, the positive electrode layer 11, the solid electrolyte layer 12, the negative electrode layer 13 and the negative electrode collector layer 14 are referred to as a first positive electrode layer 11, a first solid electrolyte layer 12, a first negative electrode layer 13 and a first negative electrode collector layer 14, respectively. Further, in the exemplary embodiment, the inside exposed part 316 provided to the laminated film 31 is referred to as a first inside exposed part 316.

### [Configuration of Lithium-Ion Rechargeable Battery]

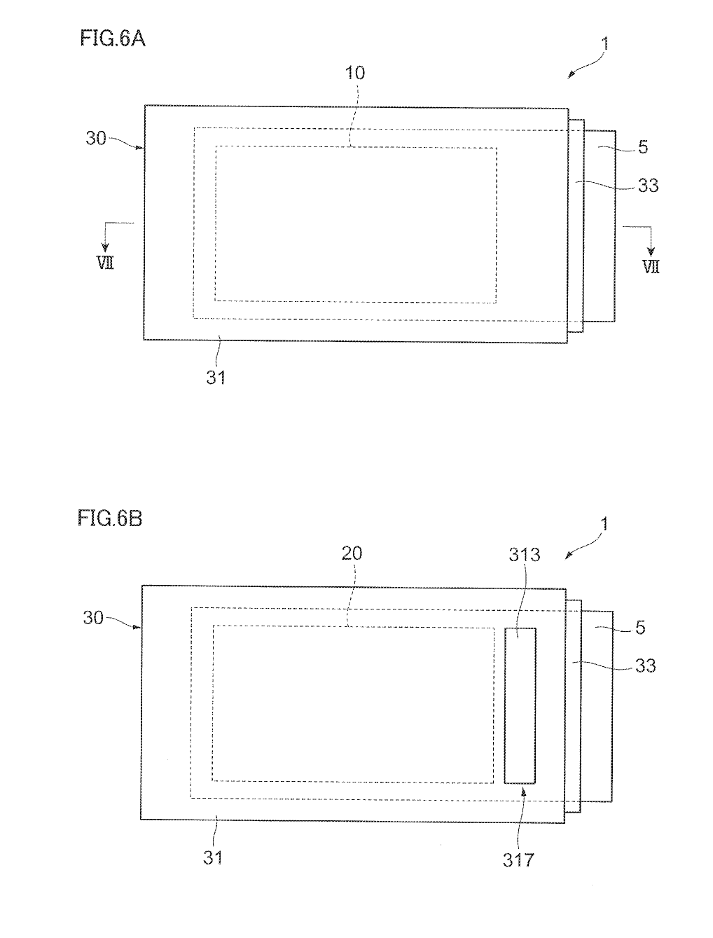

FIG. 6 is a diagram for illustrating an overall configuration of the lithium-ion rechargeable battery 1 to which the exemplary embodiment is applied. Here, FIG. 6A is a diagram in which the lithium-ion rechargeable battery 1 is viewed from the front (front surface), and FIG. 6B is a diagram in which the lithium-ion rechargeable battery 1 is viewed from the back (back surface).

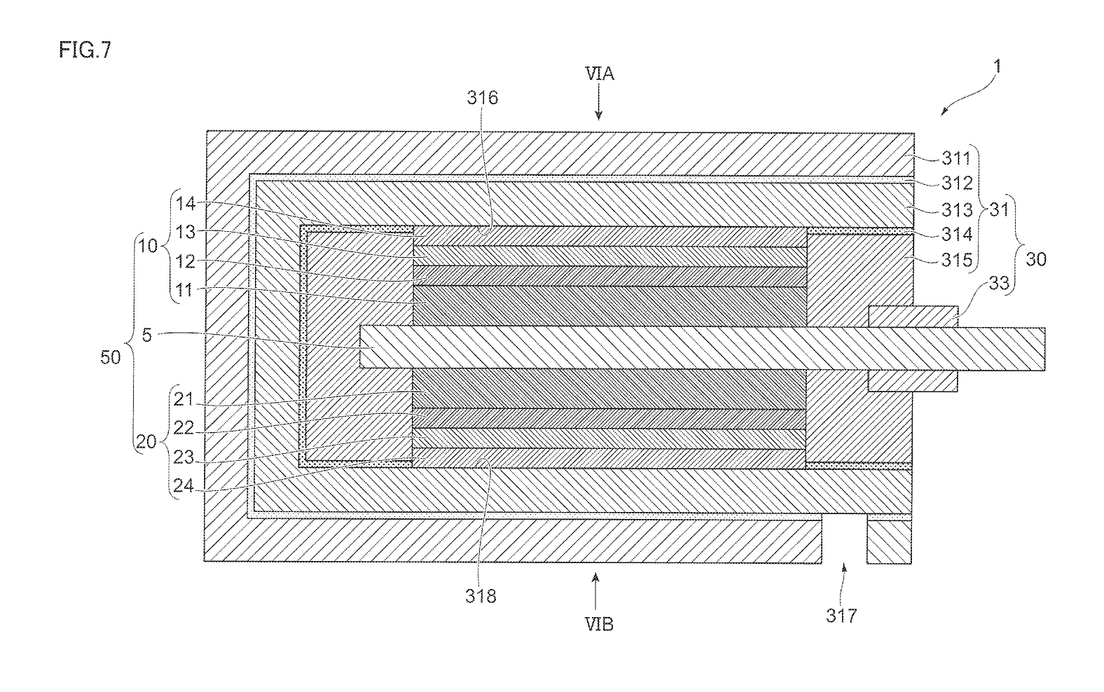

Moreover, FIG. 7 shows a VII-VII cross-sectional view of FIG. 6A. Note that FIG. 6A is a diagram viewing FIG. 7 from the VIA direction, and FIG. 6B is a diagram viewing FIG. 7 from the VIB direction.

The lithium-ion rechargeable battery 1 of the exemplary embodiment includes: the battery unit 50 including the first battery part 10 and a second battery part 20 that perform charge and discharge using lithium ion; and the shell 30 that seals the first battery part 10 and the second battery part 20 against outside air or the like by housing the first battery part 10 and the second battery part 20 in the interior thereof. The lithium-ion rechargeable battery 1 of the exemplary embodiment shows a rectangular-parallelepiped shape (in actuality, a card shape) as a whole. Note that, in the exemplary embodiment, both the first battery part 10 and the second battery part 20 function as “battery part”.

### [Configuration of Battery Unit]

The battery unit 50 includes: the substrate 5 that functions as one electrode (here, a positive electrode) in the lithium-ion rechargeable battery 1; the first battery part 10 provided to the one surface (referred to as a front surface) of the substrate 5; and the second battery part 20 provided to the other surface (referred to as a back surface) of the substrate 5. In the exemplary embodiment, since the first battery part 10 and the second battery part 20 are formed on the front and back surfaces of the substrate 5 by the sputtering method, the battery unit 50 has a configuration integrating the substrate 5, the first battery part 10 and the second battery part 20.

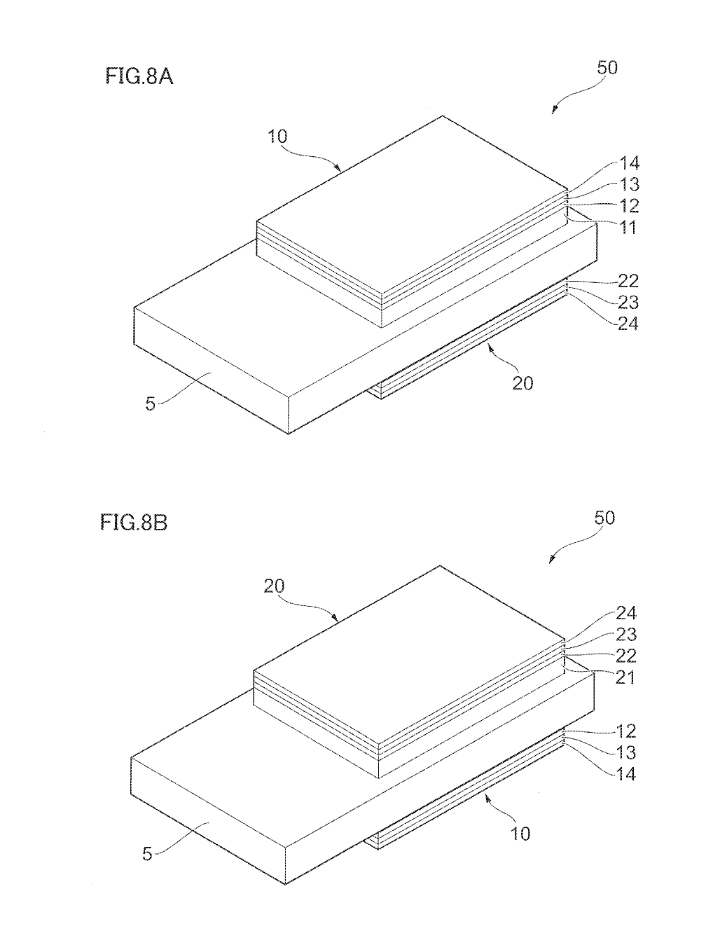

FIG. 8 shows diagrams for illustrating the configuration of the battery unit 50 in the exemplary embodiment: FIG. 8A shows a perspective view that is viewed from the front side (in FIG. 7, from above); and FIG. 8B shows a perspective view that is viewed from the back side (in FIG. 7, from below). Hereinafter, the configuration of the battery unit 50 will be described with reference to FIG. 8 in addition to FIGS. 6 and 7.

### [Substrate]

The substrate 5 is not particularly limited as long as being a thin-plate shaped member having conductivity and being suitable to be deposited by the sputtering method.

As the substrate 5, the material described in Exemplary embodiment 1 can be used. In the exemplary embodiment, as the substrate 5, 30 μm-thick stainless foil was used.

### [First Battery Part]

The first battery part 10 includes: the first positive electrode layer 11 laminated on the front surface (the upper side in FIG. 7) of the substrate 5; the first solid electrolyte layer 12 laminated on the first positive electrode layer 11; the first negative electrode layer 13 laminated on the first solid electrolyte layer 12; and the first negative electrode collector layer 14 laminated on the first negative electrode layer 13. Here, the first positive electrode layer 11 positioned on one end portion of the first battery part 10 (the lower side in FIG. 7) is in contact with the front surface of the substrate 5. In contrast thereto, the first negative electrode collector layer 14 positioned on the other end portion of the first battery part 10 (the upper side in FIG. 7) is in contact with the metal layer 313 provided to the laminated film 31.

Then, as the first positive electrode layer 11, the first solid electrolyte layer 12, the first negative electrode layer 13 and the first negative electrode collector layer 14, the respective materials described in Exemplary embodiment 1 can be used. In the exemplary embodiment, as the first positive electrode layer 11, the first solid electrolyte layer 12, the first negative electrode layer 13 and the first negative electrode collector layer 14, the 600 nm-thick Li₂Mn₂O₄ (amorphous), the 200 nm-thick LiPON (LiₓPO_{y}N_{z}) (amorphous), the 100 nm-thick silicon (Si) doped with boron (B), and the 100 nm-thick titanium (Ti) were used, respectively.

### [Second Battery Part]

The second battery part 20 includes: the second positive electrode layer 21 laminated on the back surface (the lower side in FIG. 7) of the substrate 5; the second solid electrolyte layer 22 laminated on the second positive electrode layer 21; the second negative electrode layer 23 laminated on the second solid electrolyte layer 22; and the second negative electrode collector layer 24 laminated on the second negative electrode layer 23. Here, the second positive electrode layer 21 positioned on one end portion of the second battery part 20 (the upper side in FIG. 7) is in contact with the back surface of the substrate 5. In contrast thereto, the second negative electrode collector layer 24 positioned on the other end portion of the second battery part 20 (the lower side in FIG. 7) is in contact with the metal layer 313 provided to the laminated film 31.

Each constituent of the second battery part 20 will be described in more detail.

### (Second Positive Electrode Layer)

The second positive electrode layer 21 as an example of another first polarity layer is not particularly limited as long as the layer is a solid thin film that contains a positive-electrode active material occluding and releasing lithium ions with a positive polarity as an example of the first polarity.

Then, as the second positive electrode layer 21, the material described in the above first positive electrode layer 11 can be used. At this time, the second positive electrode layer 21 and the first positive electrode layer 11 may be configured with the same material, or may be configured with different materials. Moreover, the thickness of the second positive electrode layer 21 may also be the same as or different from the thickness of the first positive electrode layer 11. However, in terms of equalizing the respective capacities of the first battery part 10 and the second battery part 20, it is preferable to equalize them. In the exemplary embodiment, as the second positive electrode layer 21, the 600 nm-thick Li₂Mn₂O₄ (amorphous) was used.

Moreover, the method for producing the second positive electrode layer 21 may be the same as or different from that of the first positive electrode layer 11; however, in terms of the production efficiency, it is preferable to adopt the same method, and further, it is more preferable to form the first positive electrode layer 11 and the second positive electrode layer 21 simultaneously.

### (Second Solid Electrolyte Layer)

The second solid electrolyte layer 22 as an example of another solid electrolyte layer is not particularly limited as long as being a solid thin film composed of an inorganic material and having lithium-ion conductivity.

Then, as the second solid electrolyte layer 22, the material described in the above first solid electrolyte layer 12 can be used. At this time, the second solid electrolyte layer 22 and the first solid electrolyte layer 12 may be configured with the same material, or may be configured with different materials. Moreover, the thickness of the second solid electrolyte layer 22 may also be the same as or different from the thickness of the first solid electrolyte layer 12. However, in terms of equalizing the respective capacities of the first battery part 10 and the second battery part 20, it is preferable to equalize them. In the exemplary embodiment, as the second solid electrolyte layer 22, the 200 nm-thick LiPON (LiₓPO_{y}N_{z}) (amorphous) was used.

Moreover, the method for producing the second solid electrolyte layer 22 may be the same as or different from that of the first solid electrolyte layer 12; however, in terms of the production efficiency, it is preferable to adopt the same method, and further, it is more preferable to form the first solid electrolyte layer 12 and the second solid electrolyte layer 22 simultaneously.

### (Second Negative Electrode Layer)

The second negative electrode layer 23 as an example of another second polarity layer is not particularly limited as long as the layer is a solid thin film that contains a negative-electrode active material occluding and releasing lithium ions with a negative polarity as an example of the second polarity.

Then, as the second negative electrode layer 23, the material described in the above first negative electrode layer 13 can be used. At this time, the second negative electrode layer 23 and the first negative electrode layer 13 may be configured with the same material, or may be configured with different materials. Moreover, the thickness of the second negative electrode layer 23 may also be the same as or different from the thickness of the first negative electrode layer 13. However, in terms of equalizing the respective capacities of the first battery part 10 and the second battery part 20, it is preferable to equalize them. In the exemplary embodiment, as the second negative electrode layer 23, the 100 nm-thick silicon (Si) added with boron (B) (amorphous) was used.

Moreover, the method for producing the second negative electrode layer 23 may be the same as or different from that of the first negative electrode layer 13; however, in terms of the production efficiency, it is preferable to adopt the same method, and further, it is more preferable to form the first negative electrode layer 13 and the second negative electrode layer 23 simultaneously.

### (Second Negative Electrode Collector Layer)

The second negative electrode collector layer 24 is not particularly limited as long as being a solid thin film having electron conductivity.

Then, as the second negative electrode collector layer 24, the material described in the above first negative electrode collector layer 14 can be used. At this time, the second negative electrode collector layer 24 and the first negative electrode collector layer 14 may be configured with the same material, or may be configured with different materials. Moreover, the thickness of the second negative electrode collector layer 24 may also be the same as or different from the thickness of the first negative electrode collector layer 14. However, in terms of equalizing the respective capacities of the first battery part 10 and the second battery part 20, it is preferable to equalize them. In the exemplary embodiment, as the second negative electrode collector layer 24, the 100 nm-thick titanium (Ti) was used.

Moreover, the method for producing the second negative electrode collector layer 24 may be the same as or different from that of the first negative electrode collector layer 14; however, in terms of the production efficiency, it is preferable to adopt the same method, and further, it is more preferable to form the first negative electrode collector layer 14 and the second negative electrode collector layer 24 simultaneously.

### [Configuration of Shell]

Subsequently, a configuration of the shell 30 will be described.

The shell 30 includes: a laminated film 31 made by laminating plural layers; and a thermo-adhesive film 33 for thermally adhering the laminated film 31 and the battery unit 50 (more specifically, the substrate 5). Then, in the shell 30, in a state in which the laminated film 31 is folded in two and the battery unit 50 is disposed inside thereof, the laminated film 31 and the thermo-adhesive film 33 are adhered to the entire circumference around each of the first battery part 10 and the second battery part 20, and thereby the first battery part 10 and the second battery part 20 are sealed. However, in the shell 30, the first battery part 10 and the second battery part 20 are sealed in a state in which one end of the substrate 5 in the battery unit 50 is exposed to the outside.

### [Laminated Film]

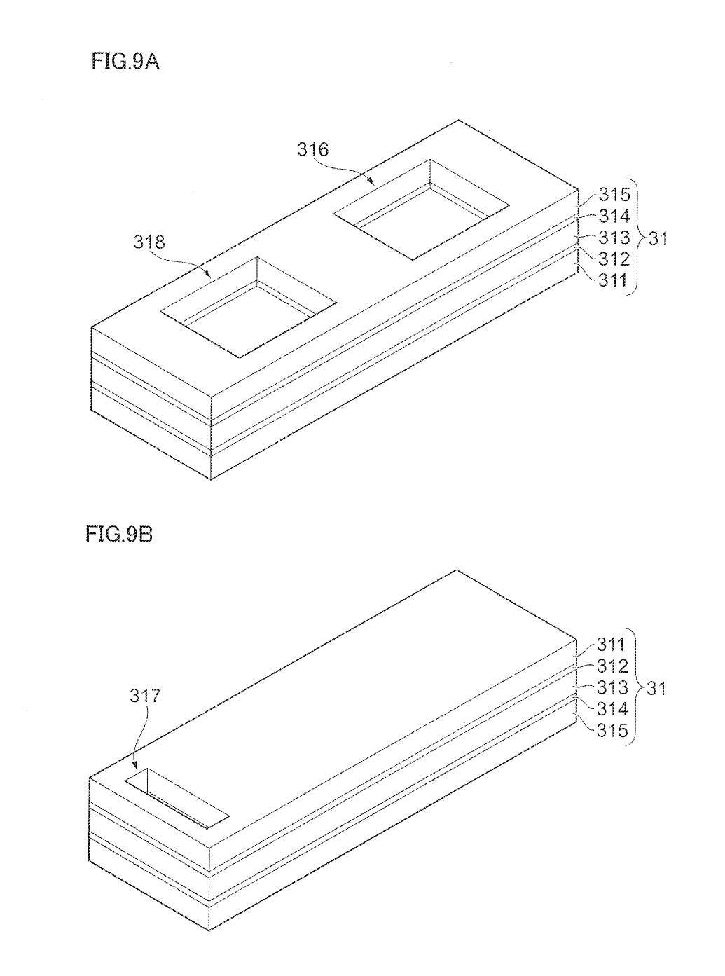

FIG. 9 shows diagrams for illustrating the configuration of the laminated film 31 in the exemplary embodiment: FIG. 9A shows a perspective view of an area that comes to the inside when the laminated film 31 is folded in two; and FIG. 9B shows a perspective view of an area that comes to the outside when the laminated film 31 is folded in two. Hereinafter, the configuration of the laminated film 31 will be described with reference to FIG. 9 in addition to FIGS. 6 to 8.

The laminated film 31 is configured by laminating a heat-resistant resin layer 311, an outside adhesion layer 312, a metal layer 313, an inside adhesion layer 314 and a thermo-adhesive resin layer 315 in a film-like shape in this order. In other words, the configuration of the laminated film 31 itself is the same as that of Exemplary embodiment 1.

Moreover, on a formation surface side of the laminated film 31, on which the thermo-adhesive resin layer 315 is formed (interior in the shell 30), there is provided a first inside exposed part 316 and a second inside exposed part 318 where a part of one surface of the metal layer 313 (inside surface) is exposed due to absence of the thermo-adhesive resin layer 315 and the inside adhesion layer 314. Here, the first inside exposed part 316 serves as an area for housing the first battery part 10 of the battery unit 50, and the second inside exposed part 318 as an example of another exposed portion serves as an area for housing the second battery part 20 of the battery unit 50.

Further, on a formation surface side of the laminated film 31, on which the heat-resistant resin layer 311 is formed (outside in the shell 30), there is provided an outside exposed part 317 where a part of the other surface of the metal layer 313 (an outside surface) is exposed due to absence of the outside adhesion layer 312 and the heat-resistant resin layer 311.

Then, as the heat-resistant resin layer 311, the outside adhesion layer 312, the metal layer 313, the inside adhesion layer 314 and the thermo-adhesive resin layer 315 constituting the laminated film 31, the respective materials described in Exemplary embodiment 1 can be used. In the exemplary embodiment, as the heat-resistant resin layer 311, the outside adhesion layer 312, the metal layer 313, the inside adhesion layer 314, and the thermo-adhesive resin layer 315, the 25 μm-thick nylon film (melting point: 220° C.), the two-pack curable type polyester-urethane adhesive agent, the 40 μm-thick aluminum foil (JIS H4160 A8021H-O), the acid-denaturated polypropylene adhesive agent, and the 30 μm-thick cast polypropylene film were used, respectively.

### [Thermo-Adhesive Film]

As the thermo-adhesive film 33, the material described in Exemplary embodiment 1 can be used. In the exemplary embodiment, as the thermo-adhesive film 33, the 10 μm-thick maleic anhydride modified polypropylene film was used.

### [Electrical Connection Structure in Lithium-Ion Rechargeable Battery]

Here, electrical connection structure in the lithium-ion rechargeable battery 1 of the exemplary embodiment will be described.

First, in the first battery part 10, the first positive electrode layer 11, the first solid electrolyte layer 12, the first negative electrode layer 13 and the first negative electrode collector layer 14 are electrically connected in this order. Moreover, in the second battery part 20, the second positive electrode layer 21, the second solid electrolyte layer 22, the second negative electrode layer 23 and the second negative electrode collector layer 24 are electrically connected in this order. Then, in the battery unit 50, on the front surface and the back surface of the substrate 5, first positive electrode layer 11 of the first battery part 10 and the second positive electrode layer 21 of the second battery part 20 are electrically connected, respectively. Here, one end side of the substrate 5 is exposed to the outside without being covered with the shell 30; the portion can be electrically connected, as a positive electrode, to the load (not shown) provided outside.

The first negative electrode collector layer 14 of the first battery part 10 is electrically connected to a portion, of one surface (inside surface) of the metal layer 313 provided to the laminated film 31, exposed to the first inside exposed part 316. Moreover, the second negative electrode collector layer 24 of the second battery part 20 is electrically connected to a portion, of one surface (inside surface) of the metal layer 313 provided to the laminated film 31, exposed to the second inside exposed part 318. Then, a part of the other surface (outside surface) of the metal layer 313 provided to the laminated film 31 is exposed at the outside exposed part 317 to the outside; the portion can be electrically connected, as a negative electrode, to the load (not shown) provided outside.

Consequently, in this example, the substrate 5 serves as the positive electrode of the lithium-ion rechargeable battery 1, and the metal layer 313 provided to the laminated film 31 serves as the negative electrode of the lithium-ion rechargeable battery 1. Moreover, in this example, the positive electrode side of the first battery part 10 and the positive electrode side of the second battery part 20 are electrically connected to the substrate 5, and the negative electrode side of the first battery part 10 and the negative electrode side of the second battery part 20 are electrically connected to the metal layer 313. Accordingly, in the lithium-ion rechargeable battery 1, the first battery part 10 and the second battery part 20 are connected in parallel. Here, the substrate 5 on the positive electrode side and the metal layer 313 on the negative electrode side are electrically insulated by the thermo-adhesive resin layer 315 provided to the laminated film 31 and the thermo-adhesive film 33.

### [Method for Producing Lithium-Ion Rechargeable Battery and Battery Unit]

The method for producing the lithium-ion rechargeable battery 1 of the exemplary embodiment is basically the same as that in Exemplary embodiment 1. However, a difference is in the point that, in the battery unit formation process shown in step 10, the first battery part 10 and the second battery part 20 are simultaneously formed on the front and back surfaces of the substrate 5. To describe more specifically, first, in the chamber of the sputtering device, the sputtering target for the first battery part 10 (for the front surface of the substrate 5) and the sputtering target for the second battery part 20 (for the back surface of the substrate 5) are prepared. Then, after the first positive electrode layer 11 and the second positive electrode layer 21 are simultaneously formed on the front and back surfaces of the substrate 5, the first solid electrolyte layer 12 and the second solid electrolyte layer 22 are simultaneously formed, the first negative electrode layer 13 and the second negative electrode layer 22 are simultaneously formed, and the first negative electrode collector layer 14 and the second negative electrode collector layer 24 are simultaneously formed.

### Conclusion of Exemplary Embodiment 2

As described above, according to the exemplary embodiment, the first battery part 10 was formed on the front surface and the second battery part 20 was formed on the back surface of the metal substrate 5, and the first battery part 10 and the second battery part 20 were housed inside of the shell 30. Moreover, in the exemplary embodiment, the first battery part 10 and the second battery part 20 were electrically connected to the metal layer 313 provided to the shell 30. This makes it possible to simplify the configuration of the lithium-ion rechargeable battery 1 in which the first battery part 10 is provided with the first solid electrolyte layer 12 and the second battery part 20 is provided with the second solid electrolyte layer 22.

### Modified Example of Exemplary Embodiment 1

In the lithium-ion rechargeable battery 1 of Exemplary embodiment 1, the battery part 10 included the negative electrode collector layer 14; however, the negative electrode collector layer 14 is not essential.

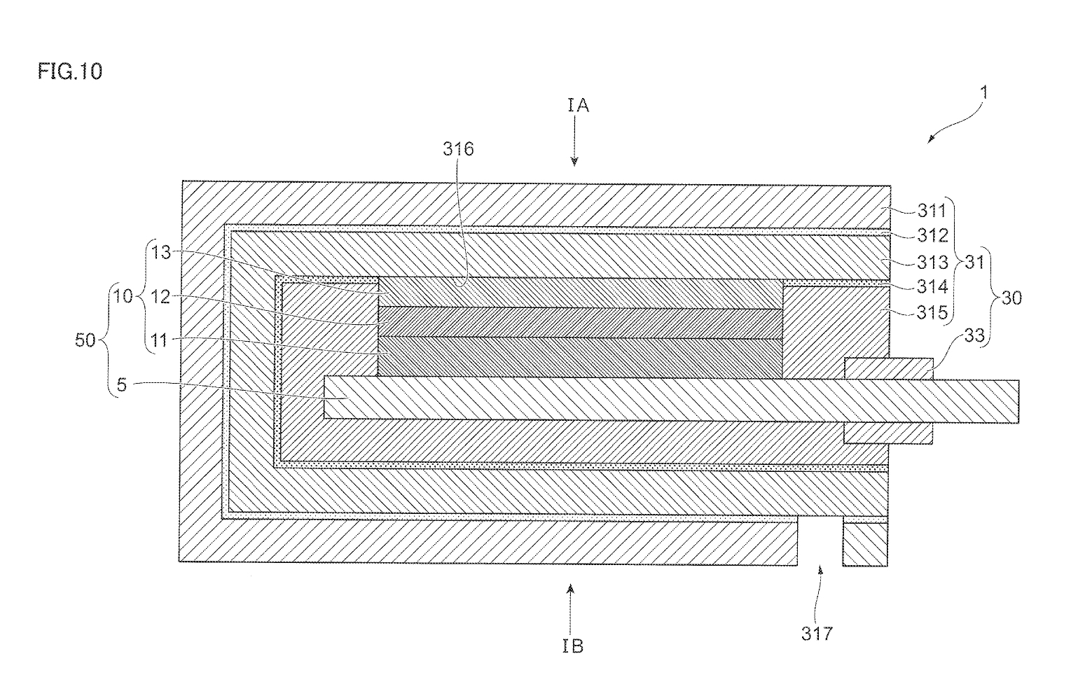

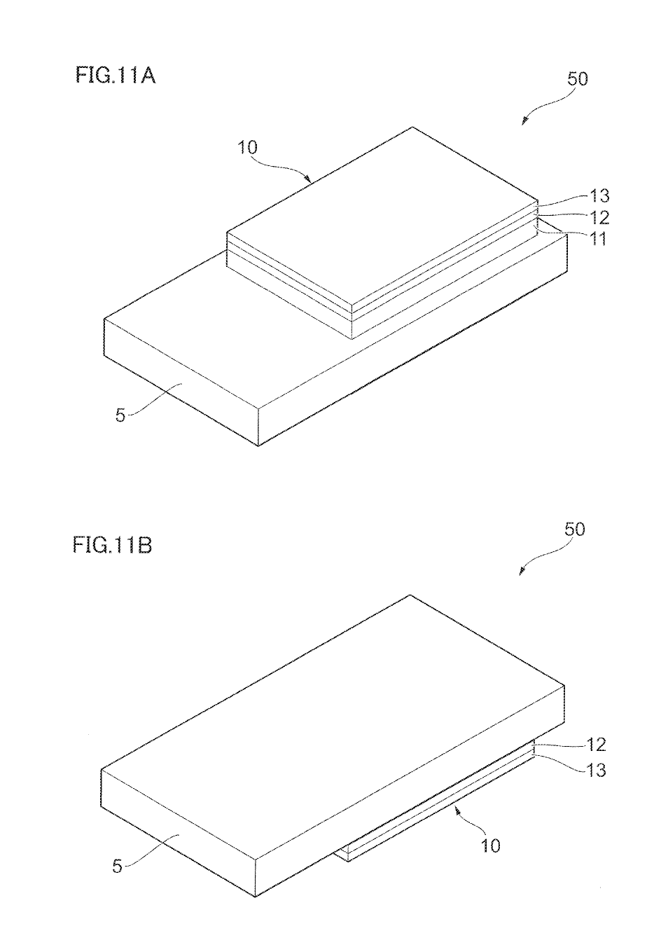

FIG. 10 is a diagram for illustrating a modified example of Exemplary embodiment 1, which is a II-II cross-sectional view of FIG. 1A. Moreover, FIGS. 11A and 11B are perspective views of the battery unit 50 in the modified example of Exemplary embodiment 1.

In the modified example of Exemplary embodiment 1, the battery part 10 constituting the battery unit 50 includes: the positive electrode layer 11 laminated on one surface of the substrate 5; the solid electrolyte layer 12 laminated on the positive electrode layer 11; and the negative electrode layer 13 laminated on the solid electrolyte layer 12. Then, the negative electrode layer 13 positioned on the other end portion of the first battery part 10 (the upper side in FIG. 10) is in direct contact with the metal layer 313 exposed to the inside exposed part 316 of the laminated film 31.

By adopting such a configuration, as compared to the configuration described in Exemplary embodiment 1, it is possible to simplify the structure of the lithium-ion rechargeable battery 1.

### Modified Example of Exemplary Embodiment 2

In the lithium-ion rechargeable battery 1 of Exemplary embodiment 2, the first battery part 10 included the first negative electrode collector layer 14 and the second battery part 20 included the second negative electrode collector layer 24; however, the first negative electrode collector layer 14 and the second negative electrode collector layer 24 are not essential.

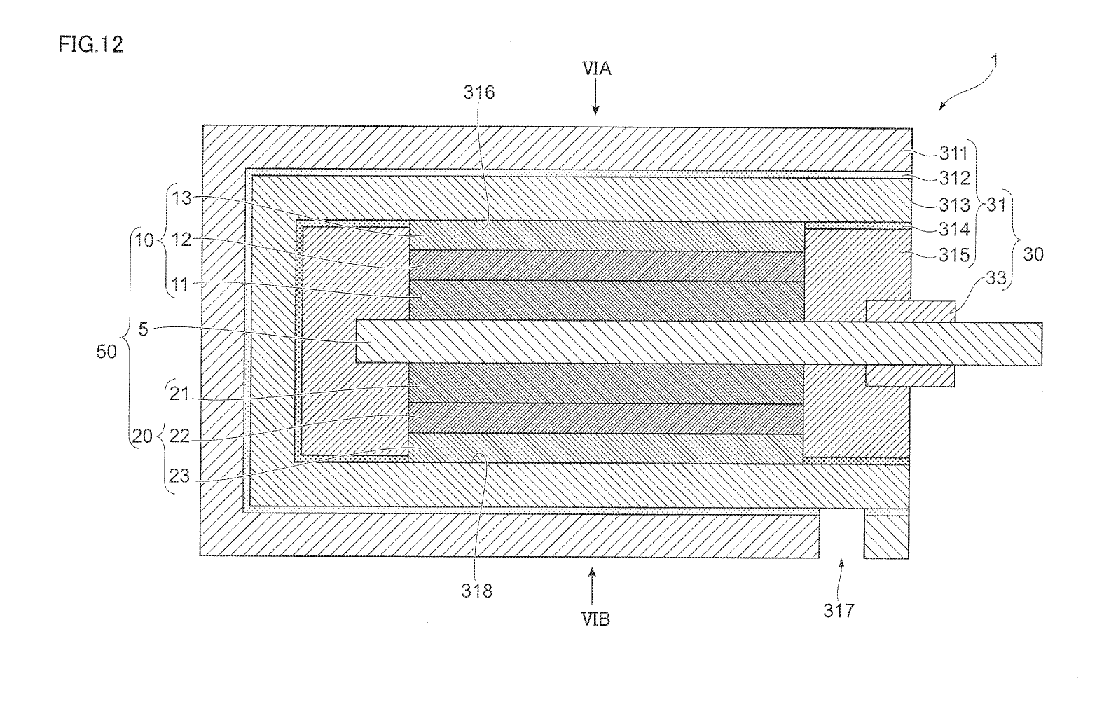

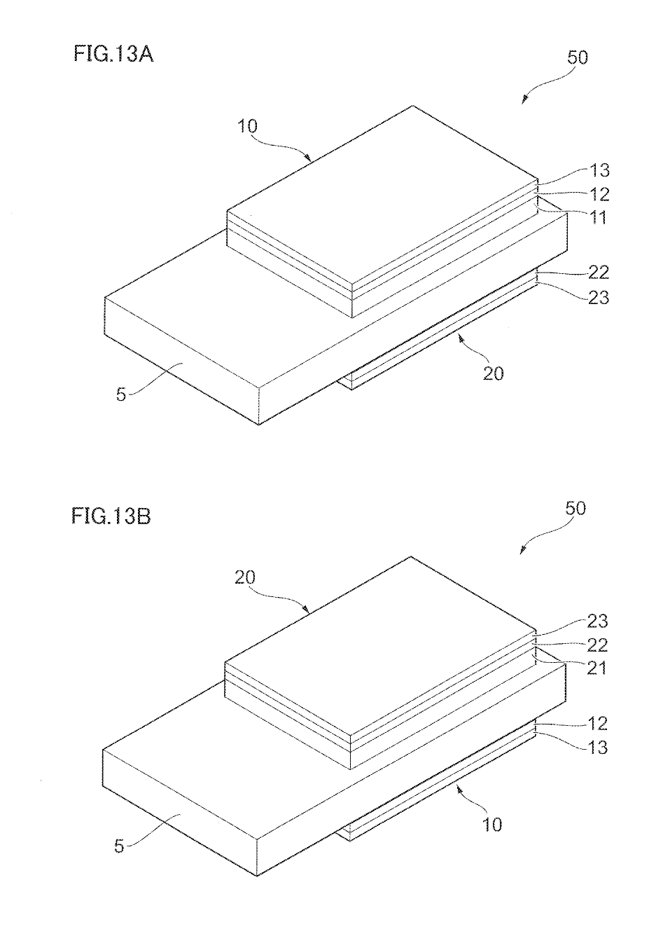

FIG. 12 is a diagram for illustrating a modified example of Exemplary embodiment 2, which is a VII-VII cross-sectional view of FIG. 6A. Moreover, FIGS. 13A and 13B are perspective views of the battery unit 50 in the modified example of Exemplary embodiment 2.

In the modified example of Exemplary embodiment 2, the first battery part 10 constituting the battery unit 50 includes: the first positive electrode layer 11 laminated on one surface of the substrate 5; the first solid electrolyte layer 12 laminated on the first positive electrode layer 11; and the first negative electrode layer 13 laminated on the first solid electrolyte layer 12. Then, the first negative electrode layer 13 positioned on the other end portion of the first battery part 10 (the upper side in FIG. 12) is in direct contact with the metal layer 313 exposed to the first inside exposed part 316 of the laminated film 31.

Moreover, the second battery part 20 constituting the battery unit 50 includes: the second positive electrode layer 21 laminated on the other surface of the substrate 5; the second solid electrolyte layer 22 laminated on the second positive electrode layer 21; and the second negative electrode layer 23 laminated on the second solid electrolyte layer 22. Then, the second negative electrode layer 23 positioned on the other end portion of the second battery part 20 (the lower side in FIG. 12) is in direct contact with the metal layer 313 exposed to the second inside exposed part 318 of the laminated film 31.

By adopting such a configuration, as compared to the configuration described in Exemplary embodiment 2, it is possible to simplify the structure of the lithium-ion rechargeable battery 1.

### <Others>

Note that, in Exemplary embodiment 1, Exemplary embodiment 2 and modified examples thereof, the positive electrode layer (the first positive electrode layer 11 (the positive electrode layer 11), the second positive electrode layer 21) is disposed on the substrate 5 side, and the negative electrode layer (the first negative electrode layer 13 (the negative electrode layer 13), the second negative electrode layer 23) is disposed on the metal layer 313 side of the laminated film 31 constituting the shell 30; however, dispositions are not limited thereto, and dispositions may be opposite. In other words, it may be possible to dispose the negative electrode side of each battery part on the substrate 5 side and to dispose the positive electrode side of each battery part on each laminated film (metal layer) side.

Moreover, in Exemplary embodiment 1 and Exemplary embodiment 2, the negative electrode collector layer 14, or the first negative electrode collector layer 14 and the second negative electrode collector layer 24 (in the modified example, the negative electrode layer 13, or the first negative electrode layer 13 and the second negative electrode layer 23), and the metal layer 313 of the laminated film 31 are brought into contact (close adhesion) without being fixed; however, the contact is not limited thereto, and the positional relationship thereof may be fixed by using, for example, a conductive adhesive agent or the like.

### REFERENCE SIGNS LIST

1 Lithium-ion rechargeable battery
5 Substrate
10 (First) battery part
11 (First) positive electrode layer
12 (First) solid electrolyte layer
13 (First) negative electrode layer
14 (First) negative electrode collector layer
20 Second battery part
21 Second positive electrode layer
22 Second solid electrolyte layer
23 Second negative electrode layer
24 Second negative electrode collector layer
30 Shell
31 Laminated film
33 Thermo-adhesive film
50 Battery unit
311 Heat-resistant resin layer
312 Outside adhesion layer
313 Metal layer
314 Inside adhesion layer
315 Thermo-adhesive resin layer
316 (First) inside exposed part
317 Outside exposed part
318 Second inside exposed part

1-6. (canceled)

7. A lithium-ion rechargeable battery comprising:
a substrate having conductivity;
a battery part including a first polarity layer laminated on one surface of the substrate to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and
a laminated film including a metal layer and a resin layer laminated on the metal layer to form an exposed portion, where a part of the metal layer is exposed, on one surface of the metal layer, the metal layer being electrically connected to the second polarity layer at the exposed portion, the laminated film sealing the battery part in a state where the metal layer is electrically insulated from the substrate.

8. The lithium-ion rechargeable battery according to claim 7, wherein
the battery part further includes another first polarity layer laminated on the other surface of the substrate to occlude and release a lithium ion with the first polarity, another solid electrolyte layer laminated on the another first polarity layer and including an inorganic solid electrolyte having lithium-ion conductivity, and another second polarity layer laminated on the another solid electrolyte layer to occlude and release a lithium ion with the second polarity, and
another exposed portion is further formed in the laminated film, and the metal layer is electrically connected to the another second polarity layer at the another exposed portion.

9. The lithium-ion rechargeable battery according to claim 7, wherein
the battery part is disposed at an interior of the laminated film folded to have the resin layer at the interior thereof, and
the battery part is sealed by adhesion of the resin layer.

10. The lithium-ion rechargeable battery according to claim 8, wherein
the battery part is disposed at an interior of the laminated film folded to have the resin layer at the interior thereof, and
the battery part is sealed by adhesion of the resin layer.

11. The lithium-ion rechargeable battery according to claim 9, wherein a part of the substrate is exposed without being covered with the laminated film.

12. The lithium-ion rechargeable battery according to claim 10, wherein a part of the substrate is exposed without being covered with the laminated film.

13. The lithium-ion rechargeable battery according to claim 7, wherein the second polarity layer provided to the battery part and the metal layer exposed at the exposed portion of the laminated film are in direct contact with each other.

14. The lithium-ion rechargeable battery according to claim 8, wherein the second polarity layer provided to the battery part and the metal layer exposed at the exposed portion of the laminated film are in direct contact with each other.

15. The lithium-ion rechargeable battery according to claim 9, wherein the second polarity layer provided to the battery part and the metal layer exposed at the exposed portion of the laminated film are in direct contact with each other.

16. The lithium-ion rechargeable battery according to claim 10, wherein the second polarity layer provided to the battery part and the metal layer exposed at the exposed portion of the laminated film are in direct contact with each other.

17. The lithium-ion rechargeable battery according to claim 11, wherein the second polarity layer provided to the battery part and the metal layer exposed at the exposed portion of the laminated film are in direct contact with each other.

18. The lithium-ion rechargeable battery according to claim 12, wherein the second polarity layer provided to the battery part and the metal layer exposed at the exposed portion of the laminated film are in direct contact with each other.

19. A method for producing a lithium-ion rechargeable battery, comprising:
a process of depositing a first polarity layer on one surface of a substrate, the first polarity layer occluding and releasing a lithium ion with a first polarity;
a process of depositing a solid electrolyte layer on the first polarity layer, the solid electrolyte layer containing an inorganic solid electrolyte having lithium-ion conductivity;
a process of depositing a second polarity layer on the solid electrolyte layer, the second polarity layer occluding and releasing a lithium ion with a second polarity, which is opposite to the first polarity; and
a process of sealing the first polarity layer, the solid electrolyte layer and the second polarity layer by adhesion of a resin layer, of a laminated film including a metal layer and the resin layer laminated on one surface of the metal layer to form an exposed portion where a part of the metal layer is exposed, in a state where the laminated film is disposed to cause the metal layer exposed at the exposed portion to face the second polarity layer.
